(19) United States
(12) Patent Application Publication
(10) Pub. No.: US 2017/0262049 A1
(43) Pub. Date: Sep. 14, 2017

(54) VIRTUAL REALITY DISPLAY BASED ON ORIENTATION OFFSET

(71) Applicant: Empire Technology Development LLC, Wilmington, DE (US)

(72) Inventor: Seungil Kim, Seoul (KR)

(73) Assignee: Empire Technology Development LLC, Wilmington, DE (US)

(21) Appl. No.: 15/067,208

(22) Filed: Mar. 11, 2016

(51) Int. Cl. G06F 3/01; G02B 27/01

(52) U.S. Cl. CPC G06F 3/012; G02B 27/017

(57) ABSTRACT

Technologies are generally described to orient virtual reality content based on user head and body orientations. In some examples, a virtual reality content display system may display different portions of virtual reality content to a user based on user head and/or body orientation. The virtual reality content display system may use a determined user body orientation to identify a first, forward portion of the virtual reality content. The virtual reality content display system may then determine where the head of the user is oriented with respect to the user body orientation, in the form of a head-body orientation offset. Upon determining a second portion of the virtual reality content corresponding to the user head orientation, the virtual reality content display system may display the second portion of the virtual reality content to the user. Portions of the virtual reality content may include distinct user interfaces of one or more applications.

### BACKGROUND

Unless otherwise indicated herein, the materials described in this section are not prior art to the claims in this application and are not admitted to be prior art by inclusion in this section.

Virtual reality systems attempt to replicate a three-dimensional, immersive environment with which a user can physically interact. Some virtual reality systems use head-mounted displays that present stereoscopic images to the user, providing an illusion of depth. These virtual reality systems may also be configured to sense user head movements and adjust the stereoscopic images presented to the user accordingly.

### SUMMARY

The present disclosure generally describes techniques to adjust virtual reality content display based on head-body orientation offset.

According to some examples, a method is provided to display content on a head-mounted display. The method may include determining a body orientation, identifying a first portion of the virtual reality content based on the body orientation, and determining a head-body orientation offset. The method may further include selecting a second portion of the virtual reality content based on the head-body orientation offset, where an offset of the second portion from the first portion corresponds to the head-body orientation offset, and displaying the selected second portion of the virtual reality content on the head-mounted display.

According to other examples, a virtual reality content display system is provided. The virtual reality content display system may include a display device configured to display virtual reality content, a head sensor configured to determine a head orientation, at least one body sensor configured to provide at least one body orientation signal, and a processor block. The processor block may be coupled to the display device, the head sensor, and the at least one body sensor, and may be configured to receive the at least one body orientation signal from the at least one body sensor, determine a first portion of the virtual reality content based on the at least one body orientation signal, and receive a head orientation signal from the head sensor. The processor block may be further configured to determine a head-body orientation offset based on the head orientation signal and the at least one body orientation signal, select a second portion of the virtual reality content based on the head-body orientation offset, and send the selected second portion to the display device for display.

According to further examples, a virtual reality content system is provided. The virtual reality content system may include a memory configured to store virtual reality content and a processor block coupled to the memory. The processor block may be configured to determine a body orientation, determine a first portion of the virtual reality content based on the body orientation, and determine a head orientation. The processor block may be further configured to determine a head-body orientation offset based on the head orientation and the body orientation, re-orient the virtual reality content based on the first portion and the head-body orientation offset, and send the re-oriented virtual reality content to a display device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example virtual reality content display system;

FIG. 2 illustrates how virtual reality content may be displayed based on head orientation;

FIG. 3 illustrates how virtual reality content may be displayed based on head-body orientation offset;

FIG. 4 illustrates how head-body orientation offset for virtual reality content display may be determined based on user feet orientation;

FIGS. 5A and 5B illustrate an example of how a user may view distinct user interfaces of one or more applications with the user interfaces being selected based on the user's head and/or body orientations;

FIGS. 6A and 6B illustrate another example of how a user may view distinct user interfaces of one or more applications with the user interfaces being selected based on the user's head and/or body orientations;

FIG. 7 illustrates how head-body orientation offset for virtual reality content display may be used to present a distinct user interface;

FIG. 8 illustrates a general purpose computing device, which may be used to provide virtual reality content display based on head-body orientation offset;

FIG. 9 is a flow diagram illustrating an example method to display virtual reality content based on head-body orientation offset that may be performed by a computing device such as the computing device in FIG. 8; and

FIG. 10 illustrates a block diagram of an example computer program product,

all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to display of virtual reality content.

Briefly stated, technologies are generally described to orient virtual reality content based on user head and body orientations. In some examples, a virtual reality content display system may display different portions of virtual reality content to a user based on a user's (e.g., a viewer's) head and/or body orientation. The virtual reality content display system may first use a determined user body orientation to identify a first, forward portion of the virtual reality content. The virtual reality content display system may then determine where the head of the user is oriented with respect to the user body orientation, in the form of a head-body orientation offset. Upon determining a second portion of the virtual reality content corresponding to the user head orientation, the virtual reality content display system may then display the second portion of the virtual reality content to the user. Portions of the virtual reality content may include distinct user interfaces of one or more applications.

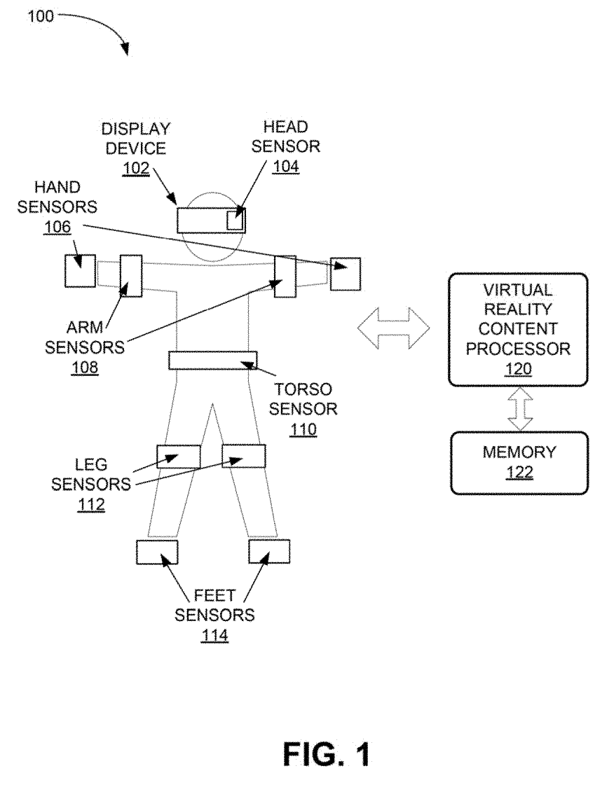

FIG. 1 illustrates an example virtual reality content display system 100, arranged in accordance with at least some embodiments described herein.

Virtual reality content display system 100 may include a display device 102 configured to display virtual reality content to a user and integrated into a head-mounted display configured to be worn on a user's head. For example, the head-mounted display may be a helmet, a headset, spectacles, goggles, or any suitable head-worn apparatus. The head-mounted display may also include a head sensor 104 configured to detect movement, acceleration, and/or orientation of the user's head.

The virtual reality content display system 100 may also include other body sensors configured to detect orientation and/or movement of the user. For example, the virtual reality content display system 100 may include hand sensors 106, arm sensors 108, torso sensors 110, leg sensors 112, feet sensors 114 (collectively, body sensors 104-114), and/or any other suitable sensor to sense user movement. In some embodiments, the body sensors 104-114 may be equipped with accelerometers, gyroscopes, and/or other devices to detect user movement and/or orientation. For example, the hand sensors 106 may be configured to detect user hand or finger orientation, movements, or gestures, and may be integrated into gloves, mittens, wristbands, or other hand-worn apparel. The arm sensors 108 may be configured to detect the orientation and/or movements of the upper arms, lower arms, and/or the elbows of the user, and may be integrated into armbands, shirt sleeves, or the like. The torso sensor 110 may be configured to detect the orientations and/or movements of the upper torso and/or abdomen of the user, and may be integrated into a waistband, a shin, or other suitable apparel. The leg sensors 112 may be configured to detect the orientations and/or movements of the thighs, calves, and/or knees of the user, and may be integrated into shorts, trousers, skirts, tights, or other suitable leg apparel. The feet sensors 114 may be configured to detect the orientations and/or movements of the feet and/or toes of the user, and may be integrated into shoes, sandals, boots, socks, or other footwear. In some embodiments, the body sensors 104-114 may be configured to operate in conjunction with external devices for user movement and/or orientation detection. For example, the body sensors 104-114 may operate in conjunction with external light sources (for example, infrared light sources) or external cameras in order to detect user movement and/or orientation.

The virtual reality content display system 100 may also include a virtual reality content processor 120 coupled to a memory 122. The virtual reality content processor 120 may be configured to retrieve virtual reality content from the memory 122 and/or from an external source via, for example, a network interface. The virtual reality content processor 120 may also be coupled to the body sensors 104-114 via wired and/or wireless connections, and may be configured to process the virtual reality content based on signals from the body sensors 104-114 and then transmit the processed content to the display device 102 for display to the user. The memory 122 in turn may store virtual reality content for the virtual reality content processor 120, or may store application or program data for execution by the virtual reality content processor 120.

Virtual reality content that represent a three-dimensional environment may have distinct directions or orientations. When head-mounted displays are used to display virtual reality content to users, the virtual reality content may be oriented with respect to the user. For example, a virtual reality system may assume that the orientation of the head-mounted display (in other words, the direction a user wearing the display is facing) when a virtual reality application is first executed should be the front or forward direction. Accordingly, when a virtual reality application begins execution, the virtual reality system may provide, for example, for display, presentation, etc., a first virtual reality content portion corresponding to the forward direction. Subsequently, when the orientation of the user's head changes, the virtual reality system may identify a second, different virtual reality content portion to be provided, for example, for display, presentation, etc., to the user based on the changed user head orientation.

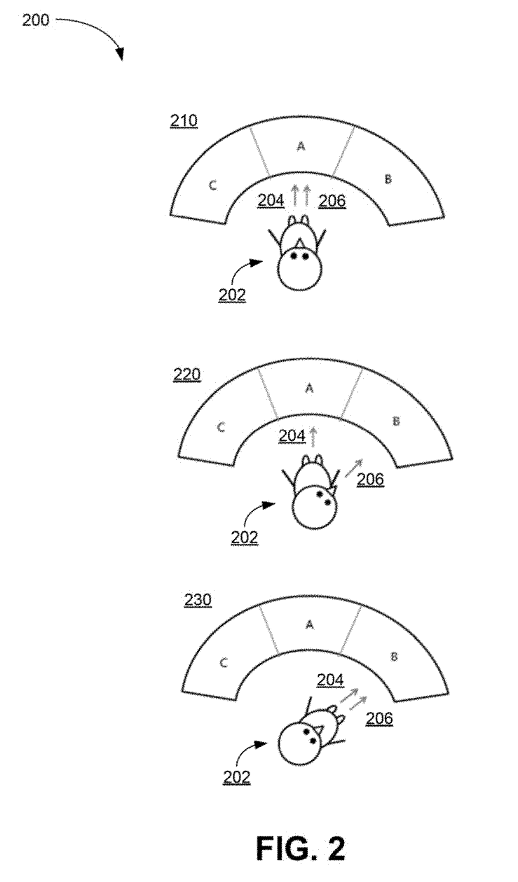

FIG. 2 illustrates how virtual reality content may be displayed based on head orientation, arranged in accordance with at least some embodiments described herein.

According to a diagram 200, a user 202 may interact with a virtual reality content display system that includes a head-mounted display configured to display virtual reality content based on user head orientation. At a time 210, a head orientation 206 of the user 202 (indicating the direction in which the head of the user 202 faces) may be substantially similar or aligned to a body orientation 204 of the user 202 (indicating the direction in which the front of the body of the user 202 faces). Also at the time 210, the virtual reality content display system may initialize a virtual reality application configured with virtual reality content portions A, B, and C. In some embodiments, the virtual reality content portion A may correspond to a front or forward-facing portion of the content, the virtual reality content portion B may correspond to a rightward-facing portion of the content, and the virtual reality content portion C may correspond to a leftward-facing portion of the content. During initialization at time 210, the virtual reality content display system may provide the forward-facing virtual reality content portion A as a first content portion for display to the user 202.

At a time 220, the user 202 may face rightward such that the head orientation 206 is now directed at the rightward-facing virtual reality content portion B while the body orientation 204 remains directed at virtual reality content portion A. The virtual reality content display system may detect the change in head orientation 206, for example using sensors in the head-mounted display as described above in FIG. 1, and accordingly may provide the rightward-facing virtual reality content portion B as a second content portion for display to the user 202.

At a time 230, the user 202 may turn rightward such that the body orientation 204 is now also directed at the rightward-facing virtual reality content portion B. In this situation, the virtual reality content display system may detect the change in the body orientation 204. However, because the head orientation 206 has not changed, the virtual reality content display system may continue to provide the rightward-facing virtual reality content portion B for display to the user 202.

The situation described in FIG. 2 may be suitable in certain circumstances. For example, if the virtual reality content represents a three-dimensional environment in which the user is free to move about, using the user head orientation to determine the virtual reality content to be displayed on the head-mounted display without taking into account user body orientation may be appropriate. However, in situations where the forward-facing virtual reality content portion is clearly distinguished from the side-facing virtual reality content portions, determining virtual reality content to display without accounting for user body orientation may not be appropriate. One example of such a situation may be a virtual work environment in which a number of screens or displays, similar to computer monitor displays, are presented to the user. In this situation, it may be natural that a particular, main display be presented to the user based on the user body orientation. Other displays may then potentially be presented to the user based on a user head-body orientation offset which may represent the difference between the user body orientation and the user head orientation.

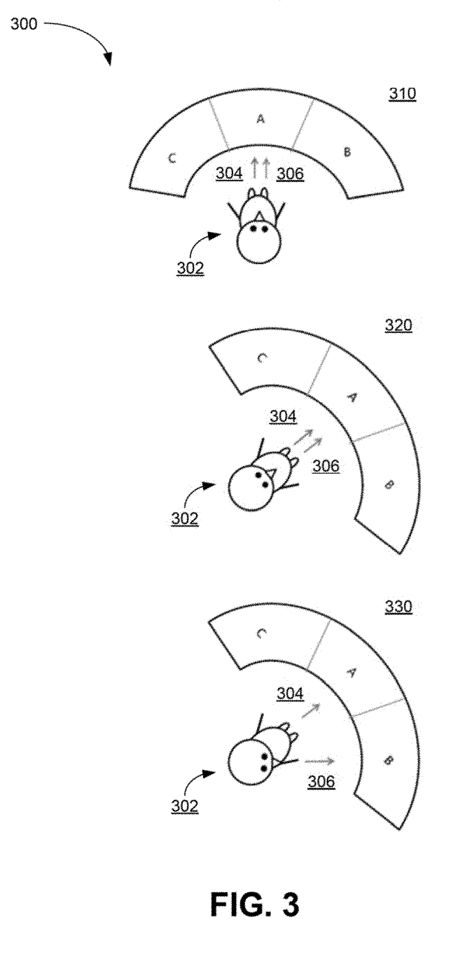

FIG. 3 illustrates how virtual reality content may be displayed based on head-body orientation offset, arranged in accordance with at least some embodiments described herein.

According to a diagram 300, which may be similar to the diagram 200, a user 302 may interact with a virtual reality content display system that includes a head-mounted display configured to display virtual reality content to the user 302. In some embodiments, the virtual reality content display system is configured to provide virtual reality content portions to display to the user 302 based on the difference between a body orientation 304 of the user 302 and a head orientation 306 of the user 302, also be referred to as a head-body orientation offset. In the diagram 300, the virtual reality content display system may execute a virtual reality application configured with virtual reality content portions A, B, and C. The virtual reality content portion A may correspond to a front or forward-facing portion of the content, the virtual reality content portion B may correspond to a rightward-facing portion of the content, and the virtual reality content portion C may correspond to a leftward-facing portion of the content.

At a time 310, the head orientation 306 of the user 302 may be substantially similar to the body orientation 304 of the user 302. The virtual reality content display system may determine that there is substantially no difference between the head orientation 306 and the body orientation 304, and that the head-body orientation offset is substantially zero. Accordingly, the virtual reality content display system may provide the forward-facing virtual reality content portion A as a first content portion for display to the user 302.

At a time 320, the user 302 may turn such that both the head orientation 306 and the body orientation 304 are rightward but still substantially similar. In this situation, the virtual reality content display system may determine that, although the user 302 has turned and both the head orientation 306 and the body orientation 304 have changed, the head-body orientation offset is still substantially zero. Accordingly, the virtual reality content display system may continue to provide the forward-facing virtual reality content portion A for display to the user 302.

At a time 320, the user 302 may face further rightward such that the head orientation 306 is now directed to the right of the body orientation 304. In this situation, the virtual reality content display system may determine that the head-body orientation offset has changed because the head orientation 306 has changed while the body orientation 304 has not changed. Accordingly, the virtual reality content display system may re-orient the virtual reality content based on the first, forward-facing virtual content portion A and the head-body orientation offset such that a virtual reality content portion with a different facing (in this case, the rightward-facing virtual reality content portion B) is provided as a second content portion for display to the user 302.

The head-body orientation offset of a user may be derived from a user head orientation and a user body orientation, as described above. The user head orientation may be determined using sensors in a head-mounted display. The user body orientation may be determined in a number of ways. According to some embodiments, the user body orientation may be determined based on user feet orientation.

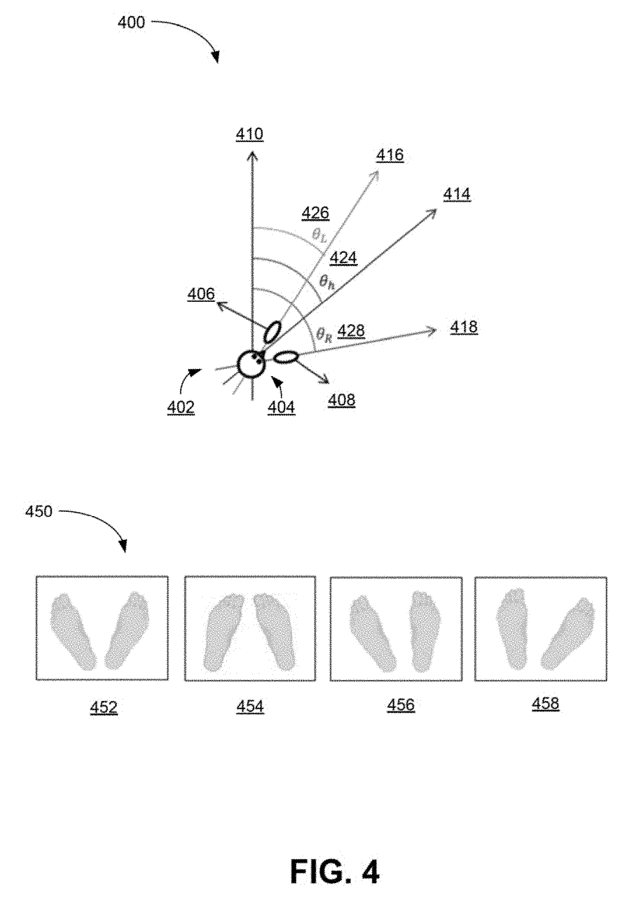

FIG. 4 illustrates how head-body orientation offset for virtual reality content display may be determined based on user feet orientation, arranged in accordance with at least some embodiments described herein.

According to a diagram 400, a virtual reality content display system may determine a head orientation 414 of a head 404 of a user 402 using, for example, a head sensor such as the head sensor 104. The virtual reality content display system may determine the head orientation 414 as an angle θₕ 424 determined with respect to an axis 410. In some embodiments, the virtual reality content display system may also be configured to receive user feet orientation data from a left foot sensor 406 and a right foot sensor 408, which may be analogous to the feet sensors 114. Based on the received user feet orientation data, the virtual reality content display system may then determine a left foot sensor orientation 416, which may be represented as an angle θ_{L} 426 determined with respect to the axis 410, and a right foot sensor orientation 418, which may be represented as an angle θ_{R} 428 determined with respect to the axis 410.

Upon the initial startup of the virtual reality content display system, the execution of a virtual reality application, or any other instance in which baseline head, body, and/or feet orientation measurements are to be taken, the virtual reality content display system may determine initial values for the angle θₕ 424, the angle θ_{L} 426, and/or the angle θ_{R} 428. The initial values may be denoted θₕ(0), θ_{L}(0), and θ_{R}(0). In some embodiments, the virtual reality content display system may be configured to assume that that a body orientation of the user 402, which may be represented as an angle θ_{B}, may have an initial value θ_{B}(0) substantially similar to the initial value θₕ(0) of the angle θₕ 424.

Upon determining the initial orientation values as described above, the virtual reality content display system may use the left foot sensor orientation 416 (denoted by the angle θ_{L} 426) and the right foot sensor orientation 418 (denoted by the angle θ_{R} 428) to determine a feet orientation pattern associated with the user 402. In some embodiments, the feet orientation pattern of a user while standing or sitting may be indicative of the user's body orientation, and different users may have different feet orientation patterns. A diagram 480 depicts potential, different user toeing or feet orientation patterns. A first user may have a toeing pattern 482 where the toes point outward, while a second user may have a toeing pattern 484 where the toes point inward. A third user may have a toeing pattern 486 that points slightly to the left and may be asymmetric with respect to the user body orientation (directed upward in the diagram 480), while a fourth user may have a toeing pattern 485 that points slightly to the right and may be asymmetric with respect to the user body orientation. In addition to variation among users, the feet orientation pattern of a particular user may even vary every time it is determined.

Accordingly, in some embodiments, the virtual reality content display system may determine variations for a user's feet orientation pattern. The virtual reality content display system may determine variations by estimating the orientation distribution value for each user foot individually. For example, the virtual reality content display system may estimate the orientation distribution value for a user's left foot as follows:

$$\begin{matrix}{σ}_{L}^{2} = E [ {( ( {θ}_{h} ( 0 ) - {θ}_{L} ( 0 ) ) - E [ ( {θ}_{h} ( 0 ) - {θ}_{L} ( 0 ) ) ] )}^{2} ] \\ = E [ {( {θ}_{h} ( 0 ) - {θ}_{L} ( 0 ) )}^{2} ] - {E}^{2} [ {θ}_{h} ( 0 ) - {θ}_{L} ( 0 ) ]\end{matrix}$$

where E represents an expectation function. The virtual reality content display system may also estimate the orientation distribution value for the user's right foot as follows:

σ_{R}²=E[(θ_{R}(0)−θₕ(0))²]−E²[θ_{R}(0)−θₕ(0)]

After the initial user feet orientations θ_{L}(0) and θ_{R}(0) have been determined, the virtual reality content display system may determine the user's current feet orientations, denoted as θ_{L}(n) and θ_{R}(n). Using the current feet orientations and the estimated orientation distribution values for each foot, the virtual reality content display system may then estimate the user's current body direction θ_{B}(n):

$${θ}_{B} ( n ) = α \cdot {θ}_{B , 1} ( n ) + ( 1 - α ) \cdot {θ}_{B , 2} ( n )$$

$$where$$

$${θ}_{B , 1} ( n ) = {θ}_{L} ( n ) + \{ {θ}_{B} ( 0 ) - {θ}_{L} ( 0 ) \}$$

$${θ}_{B , 2} ( n ) = {θ}_{R} ( n ) + \{ {θ}_{B} ( 0 ) - {θ}_{R} ( 0 ) \}$$

$$and$$

$$α = \frac{{σ}_{R}^{2}}{{σ}_{L}^{2} + {σ}_{R}^{2}}$$

$$1 - α = \frac{{σ}_{L}^{2}}{{σ}_{L}^{2} + {σ}_{R}^{2}}$$

In the above equations, θ_{B,1}(n) may represent the estimated value of the user's current body direction based on the left foot orientation θ_{L}(n), and θ_{B,2}(n) may represent the estimated value of the user's current body direction based on the right foot orientation θ_{R}(n). The parameter α may represent the degree of perturbation of the particular user's left and right feet orientation, and may be used to reduce the effect of feet orientation perturbation on the determination of the user's current body direction. For example, a large perturbation of the user's right foot orientation may result in a relatively large value for α, thereby causing the estimated value of the user's current body direction based on the left foot orientation to be more heavily weighted. Similarly, a large perturbation of the user's left foot orientation may result in a relatively large value for (1−α), thereby causing the estimated value of the user's current body direction based on the right foot orientation to be more heavily weighted.

The virtual reality content display system may then determine the user's current head direction θₕ(n) and calculate a user head-body orientation offset based on θₕ(n) and the previously-determined θ_{B}(n):

θₕ(n)−θ_{B}(n)

The virtual reality content display system may then use the calculated user head-body orientation offset to determine the appropriate portion of the virtual reality content to provide to the head-mounted display for display to the user. For example, if the calculated user head-body orientation offset is positive, the virtual reality content display system may select a rightward-facing portion of the virtual reality content to provide to the head-mounted display. As another example, if the calculated user head-body orientation offset is negative, the virtual reality content display system may select a leftward-facing portion of the virtual reality content to provide to the head-mounted display. In other embodiments where user head, body, and feet orientation angles are determined in a counterclockwise direction (in other words, opposite to the depiction in the diagram 400), positive user head-body orientation offsets may correspond to leftward-facing virtual reality content portions and negative user head-body orientation offsets may correspond to rightward-facing virtual reality content portions.

In some embodiments, the virtual reality content display system may use other inputs, such as sensor inputs from other user sensors, to determine the user head-body orientation offset and/or the virtual reality content portions to provide to the head-mounted display. For example, the virtual reality content display system may receive orientation signals from multiple user sensors distributed about or on the user, such as the body sensors 104-114. The virtual reality content display system may use the orientation signals to estimate a distribution pattern associated with the sensors and indicative of user body orientation, body position, head orientation, and/or user posture, and may use the distribution pattern to determine user body orientation, user head orientation, user head-body orientation offset, and/or any other suitable parameter.

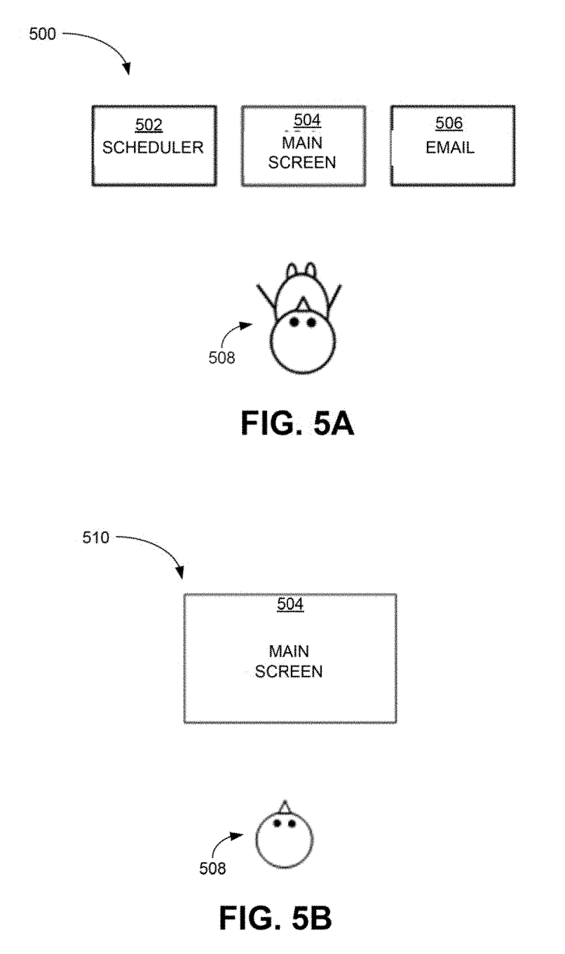

FIGS. 5A and 5B illustrate an example of how a user may view distinct user interfaces of one or more applications with the user interfaces being selected based on the user's head and/or body orientations, arranged in accordance with at least some embodiments described herein.

A scene in a virtual reality environment may be continuous. For example, the displayed scene may be part of a 360-degree video, and the scene in the 360-degree video may be selected to be displayed in a virtual reality display based on the head-body orientation offset as discussed herein. Yet, in other examples, a virtual reality scene may be discontinuous. In other words, the virtual reality scene may comprise multiple discrete views (or discrete screens), and one view (or screen) may be displayed on the virtual reality display at a time. One example implementation of this configuration may include productivity applications. User interfaces of different productivity applications may be displayed as discrete views and selected based on user body orientation, user head orientation, user head-body orientation offset, and/or any other suitable parameter according to some embodiments.

As shown in a diagram 500, a virtual reality scene comprising multiple distinct views may be similar to a user 508 working with three physical monitors in a real world. In the example configuration, a left side monitor (or screen) may display a scheduler application user interface 502, a monitor in front may display a main screen 504 (for example, a word processing application user interface or a spreadsheet application user interface), and a monitor on the right side may display an email application user interface 506. In the real world, when the user 508 turns their head to right, he or she may see the email application user interface on the right side monitor.

In a virtual reality environment according to some embodiments, one of the three user interfaces (the scheduler application user interface 502, the main screen 504, and the email application user interface 506) may be selected to be displayed to the user 508 based on the user's head/body orientation. As shown in a diagram 510, the user 508 may be presented with the main screen 504 on the virtual reality display if their head and body orientations match (for example, facing the front), that is the head-body orientation offset is substantially zero.

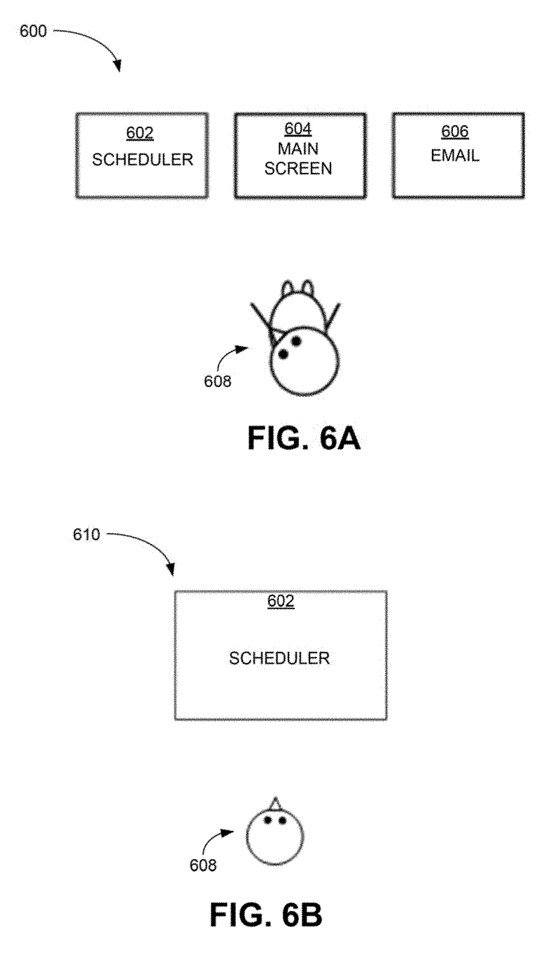

FIGS. 6A and 6B illustrate another example of how a user may view distinct user interfaces of one or more applications with the user interfaces being selected based on the user's head and/or body orientations, arranged in accordance with at least some embodiments described herein.

As shown in a diagram 600, another one of the three user interfaces (a scheduler application user interface 602, a main screen 604, and an email application user interface 606) may be selected to be displayed to a user 608 if the user's head and body orientations do not match. As shown in the example configuration of the diagram 600, the user 608 may be presented with the scheduler application user interface 602 on the virtual reality display if they turn their head to the left and their body orientation remains facing front. A diagram 610 represents this configuration from the user's viewing perspective, where the user's head (eyes) face the displayed scheduler application user interface 602.

Similarly, if the user turns their head to the left leaving their body orientation the same (facing front), they may be presented with the email application user interface 606. The example configurations in FIGS. 5A, 5B, 6A, and 6B are illustrative examples only, and do not constitute limitation on embodiments. A system according to embodiments may be implemented with fewer or higher number of distinct views than three as shown in the figures. Furthermore, the selection of the view to be displayed to the user may not necessarily be based on head/body orientation offset. As discussed herein, other parameters, such as body orientation alone, head orientation alone, feet orientation, and similar ones may also be used to select a view among multiple available views. Moreover, other application user interfaces and content delivery mechanisms may be used as distinct views among the group of views forming the virtual reality scene.

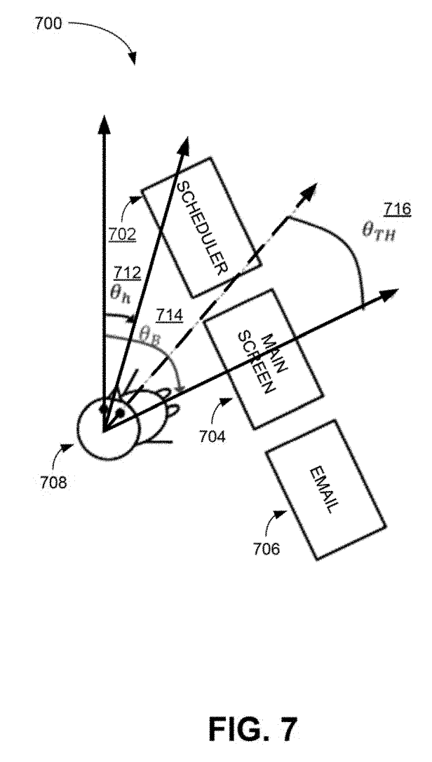

FIG. 7 illustrates how head-body orientation offset for virtual reality content display may be used to present a distinct user interface, arranged in accordance with at least some embodiments described herein.

As shown in a diagram 700, three discontinuous virtual views (screens), namely, a scheduler application user interface 702, a main screen 704, and an email application user interface 706 may be considered following the examples above. A head orientation θₕ (712) and a body orientation θ_{B} (714) may be represented as angles with respect to a selected axis, respectively. When a user 708 turns their head to left or right over an angle θ_{TH} (716), a view other than the default front view may be selected.

In the example configuration, if

θₕ−θ_{B}<−θ_{TH},

the scheduler application user interface 702 may be selected for display, where θ_{TH} is always positive (θ_{TH}>0). Alternatively, if

θₕ−θ_{B}>θ_{TH},

the email application user interface 706 may be selected for display.

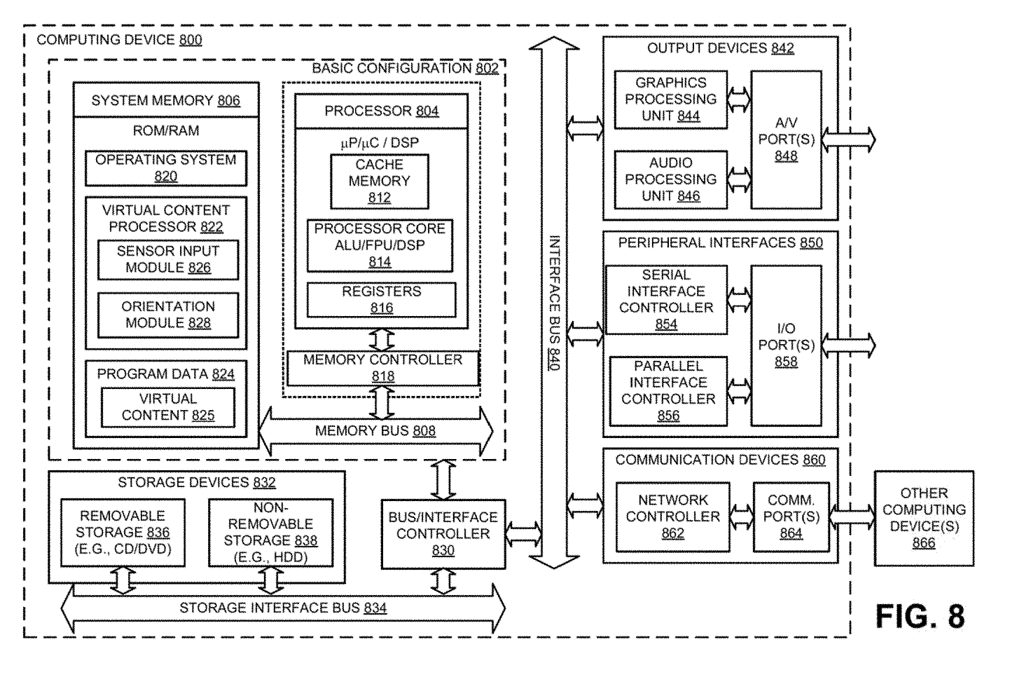

FIG. 8 illustrates a general purpose computing device, which may be used to provide virtual reality content display based on head-body orientation offset, arranged in accordance with at least some embodiments described herein.

For example, the computing device 800 may be used to orient virtual reality content based on user head and body orientations as described herein. In an example basic configuration 802, the computing device 800 may include one or more processors 804 and a system memory 806. A memory bus 808 may be used to communicate between the processor 804 and the system memory 806. The basic configuration 802 is illustrated in FIG. 8 by those components within the inner dashed line.

Depending on the desired configuration, the processor 804 may be of any type, including but not limited to a microprocessor (μP), a microcontroller (μC), a digital signal processor (DSP), or any combination thereof. The processor 804 may include one more levels of caching, such as a cache memory 812, a processor core 814, and registers 816. The example processor core 814 may include an arithmetic logic unit (ALU), a floating point unit (FPU), a digital signal processing core (DSP Core), or any combination thereof. An example memory controller 818 may also be used with the processor 804, or in some implementations the memory controller 818 may be an internal part of the processor 804.

Depending on the desired configuration, the system memory 806 may be of any type including but not limited to volatile memory (such as RAM), non-volatile memory (such as ROM, flash memory, etc.) or any combination thereof. The system memory 806 may include an operating system 820, a virtual content processor 822, and program data 824. The virtual content processor 822 may include a sensor input module 826 and an orientation module 828 to implement virtual reality content orientation based on user head and body orientations as described herein. The program data 824 may include, among other data, virtual content 825 or the like, as described herein.

The computing device 800 may have additional features or functionality, and additional interfaces to facilitate communications between the basic configuration 802 and any desired devices and interfaces. For example, a bus/interface controller 830 may be used to facilitate communications between the basic configuration 802 and one or more data storage devices 832 via a storage interface bus 834. The data storage devices 832 may be one or more removable storage devices 836, one or more non-removable storage devices 838, or a combination thereof. Examples of the removable storage and the non-removable storage devices include magnetic disk devices such as flexible disk drives and hard-disk drives (HDD), optical disk drives such as compact disc (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 806, the removable storage devices 836 and the non-removable storage devices 838 are examples of computer storage media. Computer storage media includes, but is not limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 800. Any such computer storage media may be part of the computing device 800.

The computing device 800 may also include an interface bus 840 for facilitating communication from various interface devices (e.g., one or more output devices 842, one or more peripheral interfaces 850, and one or more communication devices 860) to the basic configuration 802 via the bus/interface controller 840. Some of the example output devices 842 include a graphics processing unit 844 and an audio processing unit 846, which may be configured to communicate to various external devices such as a display or speakers via one or more A/V ports 848. One or more example peripheral interfaces 850 may include a serial interface controller 854 or a parallel interface controller 856, which may be configured to communicate with external devices such as input devices (e.g., keyboard, mouse, pen, voice input device, touch input device, etc.) or other peripheral devices (e.g., printer, scanner, etc.) via one or more I/O ports 858. An example communication device 860 includes a network controller 862, which may be arranged to facilitate communications with one or more other computing devices 866 over a network communication link via one or more communication ports 864. The one or more other computing devices 866 may include servers at a datacenter, customer equipment, and comparable devices.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 800 may be implemented as a part of a general purpose or specialized server, mainframe, or similar computer that includes any of the above functions. The computing device 800 may also be implemented as a personal computer including both laptop computer and non-laptop computer configurations.

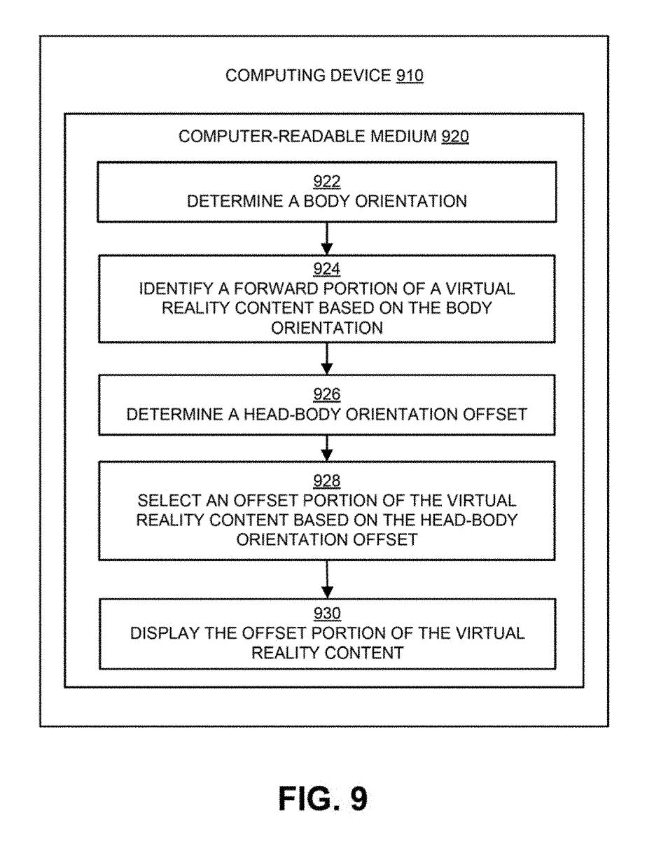

FIG. 9 is a flow diagram illustrating an example method to display virtual reality content based on head-body orientation offset that may be performed by a computing device such as the computing device in FIG. 8, arranged in accordance with at least some embodiments described herein.

Example methods may include one or more operations, functions or actions as illustrated by one or more of blocks 922, 924, 926, 928, and/or 930, and may in some embodiments be performed by a computing device such as the computing device 900 in FIG. 9. The operations described in the blocks 922-930 may also be stored as computer-executable instructions in a computer-readable medium such as a computer-readable medium 920 of a computing device 910.

An example process to orient virtual reality content based on user head and body orientations may begin with block 922, “DETERMINE A BODY ORIENTATION”, where a virtual reality content display system configured to provide virtual reality content to a head-mounted display for display to a user may determine a body orientation of the user, as described above. For example, the virtual reality content display system may use inputs from feet or shoe sensors to determine the orientation of the user's feet, and may then determine the user's body orientation based on the user feet orientation.

Block 922 may be followed by block 924, “IDENTIFY A FORWARD PORTION OF A VIRTUAL REALITY CONTENT BASED ON THE BODY ORIENTATION”, where the virtual reality content display system may determine a virtual reality content portion that should be considered the “forward” portion based on the determined user body orientation, as described above.

Block 924 may be followed by block 926, “DETERMINE A HEAD-BODY ORIENTATION OFFSET”, where the virtual reality content display system may determine a head orientation of the user, for example based on inputs from a head sensor associated with the head-mounted display, and may determine a head-body orientation offset based on the determined user head orientation and the determined user body orientation, as described above.

Block 926 may be followed by block 928, “SELECT AN OFFSET PORTION OF THE VIRTUAL REALITY CONTENT BASED ON THE HEAD-BODY ORIENTATION OFFSET”, where the virtual reality content display system may select a portion of the virtual reality content to be provided to the head-mounted display based on the determined head-body offset orientation, as described above. For example, the virtual reality content display system may select a virtual reality content portion that is offset to the right (in other words, rightward-facing with respect to the forward virtual reality content portion) upon determination that the head-body orientation offset indicates that the user is facing to the right.

Block 928 may be followed by block 930, “DISPLAY THE OFFSET PORTION OF THE VIRTUAL REALITY CONTENT”, where the virtual reality content display system may provide the selected offset portion to the head-mounted display for display to the user.

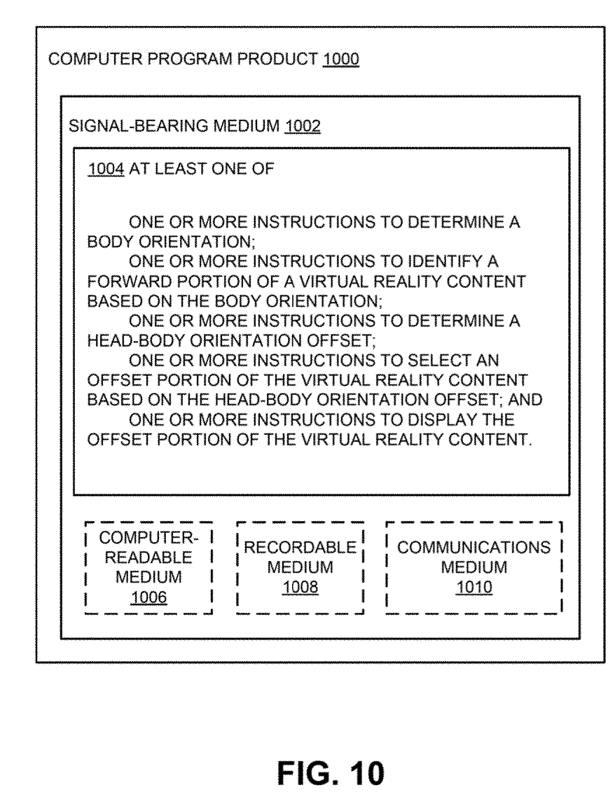

FIG. 10 illustrates a block diagram of an example computer program product, arranged in accordance with at least some embodiments described herein.

In some examples, as shown in FIG. 10, a computer program product 1000 may include a signal bearing medium 1002 that may also include one or more machine readable instructions 1004 that, when executed by, for example, a processor may provide the functionality described herein. Thus, for example, referring to the processor 804 in FIG. 8, the virtual content processor 822 may undertake one or more of the tasks shown in FIG. 10 in response to the instructions 1004 conveyed to the processor 804 by the medium 1002 to perform actions associated with orienting virtual reality content as described herein. Some of those instructions may include, for example, instructions to determine a body orientation, identify a forward portion of a virtual reality content based on the body orientation, determine a head-body orientation offset, select an offset portion of the virtual reality content based on the head-body orientation offset, and/or display the offset portion of the virtual reality content, according to some embodiments described herein.

According to some examples, a method is provided to display content on a head-mounted display. The method may include determining a body orientation, identifying a first portion of the virtual reality content based on the body orientation, and determining a head-body orientation offset. The method may further include selecting a second portion of the virtual reality content based on the head-body orientation offset, where an offset of the second portion from the first portion corresponds to the head-body orientation offset, and displaying the selected second portion of the virtual reality content on the head-mounted display.

According to some embodiments, the method may further include receiving an orientation signal from a body sensor, and determining the body orientation may include determining the body orientation based on the orientation signal. The body sensor may include a first foot sensor and/or a second foot sensor, and the orientation signal may include a first signal from the first foot sensor and/or a second signal from the second foot sensor. The method may further include determining a first orientation of the first foot sensor based on the first signal and determining a second orientation of the second foot sensor based on the second signal. Determining the body orientation may include determining an orientation pattern based on the first orientation and the second orientation, and estimating a body direction based on the orientation pattern. The method may further include determining an initial toeing pattern, and determining the orientation pattern may include determining the orientation pattern based on the first orientation, the second orientation, and the toeing pattern.

According to other embodiments, the method may further include estimating a distribution pattern associated with multiple body sensors, and determining the body orientation may further include determining the body orientation based on multiple orientation signals from the multiple body sensors and the distribution pattern. The method may further include determining a head orientation, and determining the head-body orientation offset may include determining the head-body orientation offset based on the body orientation and the head orientation. The first portion and the second portion of the virtual reality content may include two distinct user interfaces. At least one of the two distinct user interfaces may include an application user interface, and at least one of the two distinct user interfaces may include a desktop user interface.

According to other examples, a virtual reality content display system is provided. The virtual reality content display system may include a display device configured to display virtual reality content, a head sensor configured to determine a head orientation, at least one body sensor configured to provide at least one body orientation signal, and a processor block. The processor block may be coupled to the display device, the head sensor, and the at least one body sensor, and may be configured to receive the at least one body orientation signal from the at least one body sensor, determine a first portion of the virtual reality content based on the at least one body orientation signal, and receive a head orientation signal from the head sensor. The processor block may be further configured to determine a head-body orientation offset based on the head orientation signal and the at least one body orientation signal, select a second portion of the virtual reality content based on the head-body orientation offset, and send the selected second portion to the display device for display.

According to some embodiments, the at least one body sensor may include a first shoe sensor and a second shoe sensor, and the at least one body orientation signal may include a first signal from the first shoe sensor and a second signal from the second shoe sensor. The processor block may be further configured to determine a first orientation of the first shoe sensor based on the first signal and determine a second orientation of the second shoe sensor based on the second signal. The processor block may be further configured to determine an orientation pattern based on the first orientation and the second orientation and estimate a body direction based on the orientation pattern to determine the first portion of the virtual reality content and determine the head-body orientation offset. The processor block may be further configured to determine an initial toeing pattern and determine the orientation pattern based on the first orientation, the second orientation, and the toeing pattern.

According to other embodiments, the processor block may be further configured to estimate a distribution pattern associated with the at least one body sensor and use the distribution pattern to determine the first portion of the virtual reality content and the head-body orientation offset. The display device may be a head-mounted display including the head sensor. The processor block may also select a portion of the virtual reality content among portions of the virtual reality content based on the head-body orientation offset. The portions of the virtual reality content may include distinct application user interfaces. The application user interfaces may include productivity application user interfaces.

According to further examples, a virtual reality content system is provided. The virtual reality content system may include a memory configured to store virtual reality content and a processor block coupled to the memory. The processor block may be configured to determine a body orientation, determine a first portion of the virtual reality content based on the body orientation, and determine a head orientation. The processor block may be further configured to determine a head-body orientation offset based on the head orientation and the body orientation, re-orient the virtual reality content based on the first portion and the head-body orientation offset, and send the re-oriented virtual reality content to a display device.

According to some embodiments, the processor block may be further configured to receive at least one orientation signal from a body sensor and use the orientation signal to determine the body orientation. The orientation signal may include a first foot orientation signal and/or a second foot orientation signal. The processor block may be further configured to determine an orientation pattern based on the first orientation and/or the second orientation and estimate a body direction based on the orientation pattern to determine the body orientation. The processor block may be further configured to determine an initial toeing pattern and determine the orientation pattern based on the first orientation, the second orientation, and/or the toeing pattern.

According to other embodiments, the processor block may be further configured to estimate a distribution pattern associated with the body orientation and determine the body orientation based on the orientation signal and the distribution pattern. The processor block may be further configured to receive a head orientation signal from the display device and determine the head orientation based on the head orientation signal.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and that designing the circuitry and/or writing the code for the software and/or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a compact disc (CD), a digital versatile disk (DVD), a digital tape, a computer memory, a solid state drive, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors to move and/or adjust components and/or quantities).

A data processing system may be implemented utilizing any suitable commercially available components, such as those found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of“two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-8 cells refers to groups having 1, 2, 3, 4, or 8 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method to display virtual reality content on a head-mounted display, the method comprising:
determining a body orientation;
identifying a first portion of the virtual reality content based on the body orientation;
determining a head-body orientation offset;
selecting a second portion of the virtual reality content based on the head-body orientation offset, wherein an offset of the second portion from the first portion corresponds to the head-body orientation offset; and
displaying the selected second portion of the virtual reality content on the head-mounted display.

2. The method of claim 1, further comprising receiving an orientation signal from a body sensor, and wherein determining the body orientation comprises determining the body orientation based on the orientation signal.

3. The method of claim 2, wherein:
the body sensor includes one or more of a first foot sensor and a second foot sensor,
the orientation signal includes one or more of a first signal from the first foot sensor and a second signal from the second foot sensor.

4. The method of claim 3, further comprising:
determining a first orientation of the first foot sensor based on the first signal; and
determining a second orientation of the second foot sensor based on the second signal;
and wherein determining the body orientation comprises:
determining an orientation pattern based on the first orientation and the second orientation; and
estimating a body direction based on the orientation pattern.

8. The method of claim 4, further comprising determining an initial toeing pattern, and wherein determining the orientation pattern comprises determining the orientation pattern based on the first orientation, the second orientation, and the toeing pattern.

6. The method of claim 2, further comprising estimating a distribution pattern associated with a plurality of body sensors, and wherein determining the body orientation further comprises determining the body orientation based on a plurality of orientation signals from the plurality of body sensors and the distribution pattern.

7. The method of claim 1, further comprising determining a head orientation, and wherein determining the head-body orientation offset comprises determining the head-body orientation offset based on the body orientation and the head orientation.

8. The method of claim 1, wherein the first portion and the second portion of the virtual reality content include two distinct user interfaces.

9. The method of claim 8, wherein the at least one of the two distinct user interfaces includes an application user interface.

10. The method of claim 8, wherein the at least one of the two distinct user interfaces includes a desktop user interface.

11. A virtual reality content display system comprising:
a display device configured to display virtual reality content;
a head sensor configured to determine a head orientation;
at least one body sensor configured to provide at least one body orientation signal; and
a processor block coupled to the display device, the head sensor, and the at least one body sensor, and configured to:
receive the at least one body orientation signal from the at least one body sensor;
determine a first portion of the virtual reality content based on the at least one body orientation signal;
receive a head orientation signal from the head sensor;
determine a head-body orientation offset based on the head orientation signal and the at least one body orientation signal;
select a second portion of the virtual reality content based on the head-body orientation offset; and
send the selected second portion to the display device for display.

12. The virtual reality content display system of claim 11, wherein:
the at least one body sensor includes a first shoe sensor and a second shoe sensor,
the at least one body orientation signal includes a first signal from the first shoe sensor and a second signal from the second shoe sensor.

13. The virtual reality content display system of claim 12, wherein the processor block is further configured to:
determine a first orientation of the first shoe sensor based on the first signal;
determine a second orientation of the second shoe sensor based on the second signal;
determine an orientation pattern based on the first orientation and the second orientation; and
estimate a body direction based on the orientation pattern to determine the first portion of the virtual reality content and determine the head-body orientation offset.

14. The virtual reality content display system of claim 13, wherein the processor block is further configured to:
determine an initial toeing pattern, and
determine the orientation pattern based on the first orientation, the second orientation, and the toeing pattern.

15. The virtual reality content display system of claim 1, wherein the processor block is further configured to:
estimate a distribution pattern associated with the at least one body sensor, and
use the distribution pattern to determine the first portion of the virtual reality content and the head-body orientation offset.

16. The virtual reality content display system of claim 11, wherein the processor block is further configured to:
select a portion of the virtual reality content among a plurality of portions of the virtual reality content based on the head-body orientation offset.

17. The virtual reality content display system of claim 16, wherein the plurality of portions of the virtual reality content include distinct application user interfaces.

18. The virtual reality content display system of claim 17, wherein the application user interfaces include productivity application user interfaces.

19. A virtual reality content system comprising:
a memory configured to store virtual reality content; and
a processor block coupled to the memory and configured to:
determine a body orientation;
determine a first portion of the virtual reality content based on the body orientation;
determine a head orientation;
determine a head-body orientation offset based on the head orientation and the body orientation;
re-orient the virtual reality content based on the first portion and the head-body orientation offset; and
send the re-oriented virtual reality content to a display device.

20. The virtual reality content system of claim 19, wherein the processor block is further configured to:
receive at least one orientation signal from a body sensor, and
use the orientation signal to determine the body orientation.

21. The virtual reality content system of claim 20, wherein the orientation signal includes one or more of a first foot orientation signal and a second foot orientation signal.

22. The virtual reality content system of claim 19, wherein the processor block is further configured to:
determine an orientation pattern based on one or more of the first orientation and the second orientation; and
estimate a body direction based on the orientation pattern to determine the body orientation.

23. The virtual reality content system of claim 19, wherein the processor block is further configured to:
determine an initial toeing pattern, and
determine the orientation pattern based on one or more of the first orientation, the second orientation, and the toeing pattern.

24. The virtual reality content system of claim 23, wherein the processor block is further configured to:
estimate a distribution pattern associated with the body orientation, and
determine the body orientation based on the orientation signal and the distribution pattern.
